(19) United States
(12) Patent Application Publication
(10) Pub. No.: US 2013/0296046 A1
(43) Pub. Date: Nov. 7, 2013

(54) SYSTEM AND METHOD FOR COLLABORATIVE SHOPPING THROUGH SOCIAL GAMING

(71) Applicant: Marty Mianji, Lake Oswego, OR (US)

(72) Inventor: Marty Mianji, Lake Oswego, OR (US)

(21) Appl. No.: 13/854,046

(22) Filed: Mar. 29, 2013

Related U.S. Application Data
(60) Provisional application No. 61/617,688, filed on Mar. 30, 2012.

(51) Int. Cl. A63F 13/00

(52) U.S. Cl. CPC A63F 13/00
USPC 463/31

(57) ABSTRACT

Some embodiments of the invention provide a method for collaborative shopping through social gaming. In some embodiments, a shopping mechanism is provided that allows for interactive targeted or browse-type shopping with other shoppers and experts through online social gaming.

### CLAIM OF BENEFIT TO PRIOR APPLICATION

This application claims the benefit of U.S. Provisional Application 61/617,688, entitled “System and Method for Collaborative Shopping Through Social Gaming”, filed Mar. 30, 2012, which is incorporated herein by reference.

### BACKGROUND

The Internet continues to grow as an alternate “living space” where greater and greater numbers of people throughout the world spend significant amounts of time to learn, shop, make friends, and communicate. A relevant and nascent genre of online applications that has been gaining popularity as a result is online social gaming, serving as a vehicle for social interaction.

Ecommerce applications have also improved significantly since their inception nearly 20 years ago. Most of these enhancements, however, have been in the areas of logistics and competitive pricing, and have not been truly able to reflect the social nature of shopping. Shopping in real life is not a mechanical process during which shoppers systematically search for products based on predefined categories, read product reviews and form a unified mental image based on them, and then decide to press the “buy” button. Shopping in real life is often a social activity where shoppers engage with others who help shape their buying decisions.

Ecommerce has accomplished a great deal in the area of increasing the efficiency of buying online, especially if shoppers know what they are looking for. However, if a shopper is simply browsing and shopping around to get ideas for something to buy, ecommerce is still lacking. Traditional ecommerce applications such as Amazon assume single-user searches for products, and disregard the benefits that interactive group shopping and added expert opinions can lend to the process. Therefore, there is a need for a system to bring together ecommerce with collaborative shopping, and a social gaming application with a shopping theme accomplishes this.

### BRIEF SUMMARY

Some embodiments of the invention provide a method for collaborative shopping through social gaming. In some embodiments, this method is implemented using a web application with Graphical User Interface (GUI) tools.

Some embodiments provide a shopping mechanism for targeted shopping. In some embodiments, this shopping mechanism includes a means to shop through a social gaming interface by selecting categories and sub-categories of interest. In some embodiments, to help select categories and subcategories, other players in the same social network may communicate their opinions or special players with expertise in the area may be selected to offer opinions too. Some embodiments also provide a follow mechanism to follow special players with expertise and allow them to provide future shopping recommendations and opinions.

Some embodiments provide a shopping mechanism for browse shopping. In some embodiments, this shopping mechanism includes a means to shop through a social gaming interface by utilizing randomized browsing of all types of computer-generated suggestions, category browsing of all types of computer-generated suggestions in a selected category, targeted browsing of all types of computer-generated suggestions in a selected category and subcategory of goods, or browsing of all types of computer-generated suggestions based on a selected functionality.

Some embodiments provide a multicast tool to provide shopping suggestions. In some embodiments, the multicast tool allows experts in different areas of shopping to address certain common issues or concerns to a group of shoppers at the same time.

Some embodiments provide mini-game and quest tools that allows earning shopping rewards including but not limited to virtual currency, in-game assets, real currency, or real goods and services.

The preceding Brief Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Brief Summary as well as other embodiments. Accordingly, to understand all the embodiments described in this document, a full review of the Brief Summary, Detailed Description and the Drawings is needed. Moreover, the claimed subject matters are not to be limited to the illustrative details in the Brief Summary, Detailed Description and the Drawings, but rather are to be defined by the appended claims because the claimed subject matters can be embodied in other specific forms without departing from the spirit of the subject matters.

### BRIEF DESCRIPTION OF THE DRAWINGS

The novel features of the invention are set forth in the appended claims. However, for the purpose of explanation, several embodiments of the invention are set forth in the following figures.

FIG. 1 is a flowchart that conceptually illustrates an example of a process that some embodiments use to shop using a social gaming interface

FIG. 2 illustrates an example shopping GUI for an online social game.

FIG. 3 illustrates an example shopping GUI for an online social game.

FIG. 4 illustrates an example shopping GUI for an online social game.

FIG. 5 illustrates an example shopping GUI for an online social game.

FIG. 6 illustrates an example shopping GUI for an online social game.

FIG. 7 illustrates an example shopping GUI for an online social game.

FIG. 8 illustrates an example rating GUI for an online social game.

FIG. 9 illustrates an example shopping GUI for an online social game.

FIG. 10 illustrates an example shopping GUI for an online social game.

FIG. 11 illustrates an example browsing GUI for an online social game.

FIG. 12 illustrates an example browsing GUI for an online social game.

FIG. 13 illustrates an example multicast GUI for an online social game.

FIG. 14 illustrates an example multicast GUI for an online social game.

FIG. 15 is a flowchart that conceptually illustrates the process for a computer generated online mini game.

FIG. 16 illustrates an example mini game GUI for an online social game.

FIG. 17 is a flowchart that conceptually illustrates the process for a computer generated mini game played in an online social game.

FIG. 18 illustrates an example mini game GUI for an online social game.

FIG. 19 illustrates an example mini game GUI for an online social game.

FIG. 20 illustrates an example mini game GUI for an online social game.

FIG. 21 illustrates an example mini game GUI for an online social game.

FIG. 22 illustrates an example player generated quest creation GUI at first glance for an online social game.

FIG. 23 illustrates an example quest creation GUI for an online social game.

FIG. 24 illustrates an example quest creation GUI for an online social game.

FIG. 25 illustrates an example quest GUI for an online social game.

FIG. 26 illustrates an example quest GUI for an online social game.

FIG. 27 illustrates an example overall system architecture that can implement some embodiments of the invention.

FIG. 28 illustrates a computer system by which some embodiments are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed below.

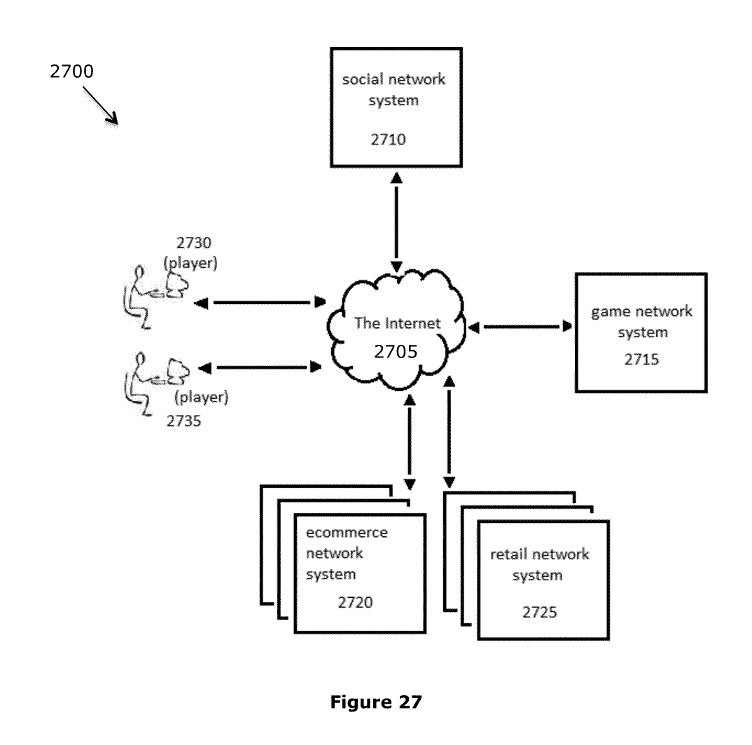

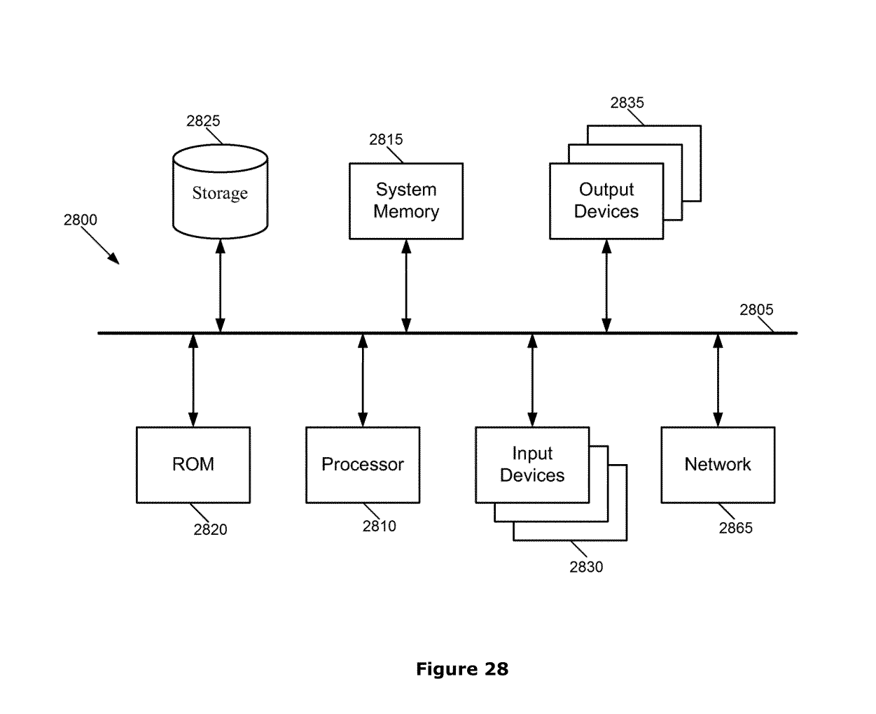

This disclosure generally describes a system and method for collaborative shopping through social gaming. More specifically, it describes some embodiments of a shopping-based online social game that enables players to independently or collaboratively search for in-game assets in a virtual world. Examples of in-game assets include but are not limited to electronics (e.g., wireless devices, computers, handheld devices, etc.), literature (e.g., books, e-books, magazines, etc.), clothing (e.g., shirts, pants, dresses, jackets, shoes, etc.), accessories (e.g., purses, sunglasses, belts, etc.), and home goods (e.g., furniture, bedding, etc.). A player's character state is determined by the types and number of in-game assets owned by a player. It will be understood to one of ordinary skill in the art that “player” and “shopper” and “user” may be used interchangeably where appropriate and that “shopping” and “searching” may be used interchangeably where appropriate. Some embodiments of the game system architecture and game server will be further discussed below in FIGS. 27-28.

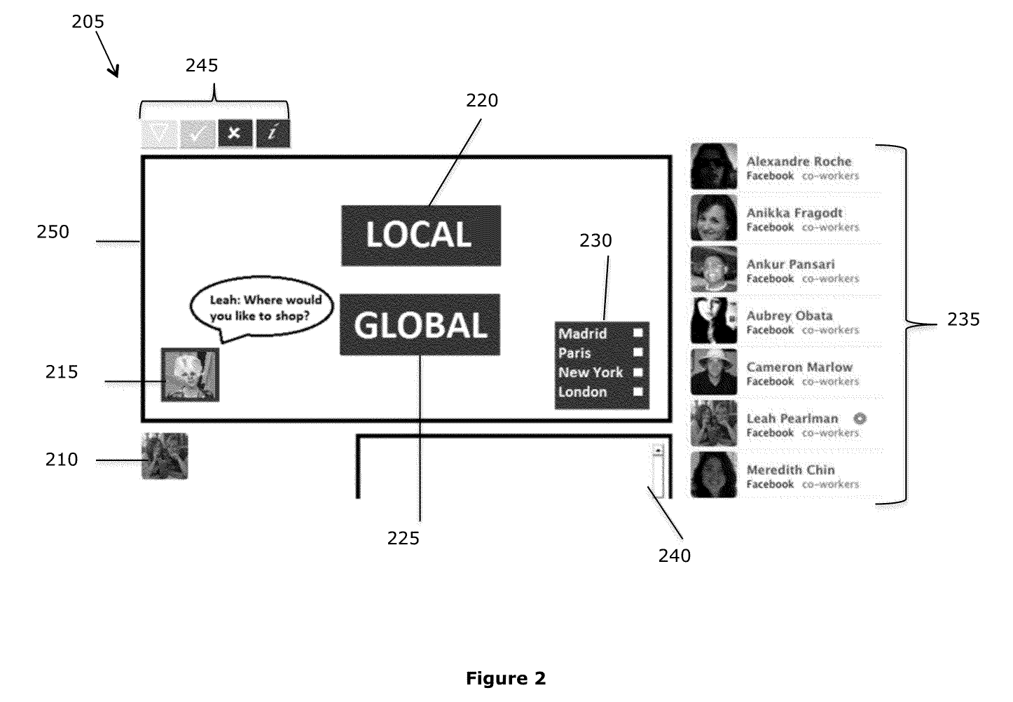

Some embodiments of the invention implement a method for shopping for in-game assets in an online social game using an example game interface that is embedded in a social networking website (e.g., Facebook, MySpace, Twitter, etc.) and accessed using a browser client (e.g., Google Chrome, Internet Explorer, Safari, Firefox, etc.). FIGS. 2-14 illustrate various game interfaces of the example application of some embodiments of the invention.

Although some embodiments show these processes being implemented on a sample web interface, one of ordinary skill in the art will understand that many of these processes can be used together or separately in a large number of other areas and scenarios. In addition, these processes can be used with client applications on any platform, system, and device.

I. Shopping Through a Social Game Interface

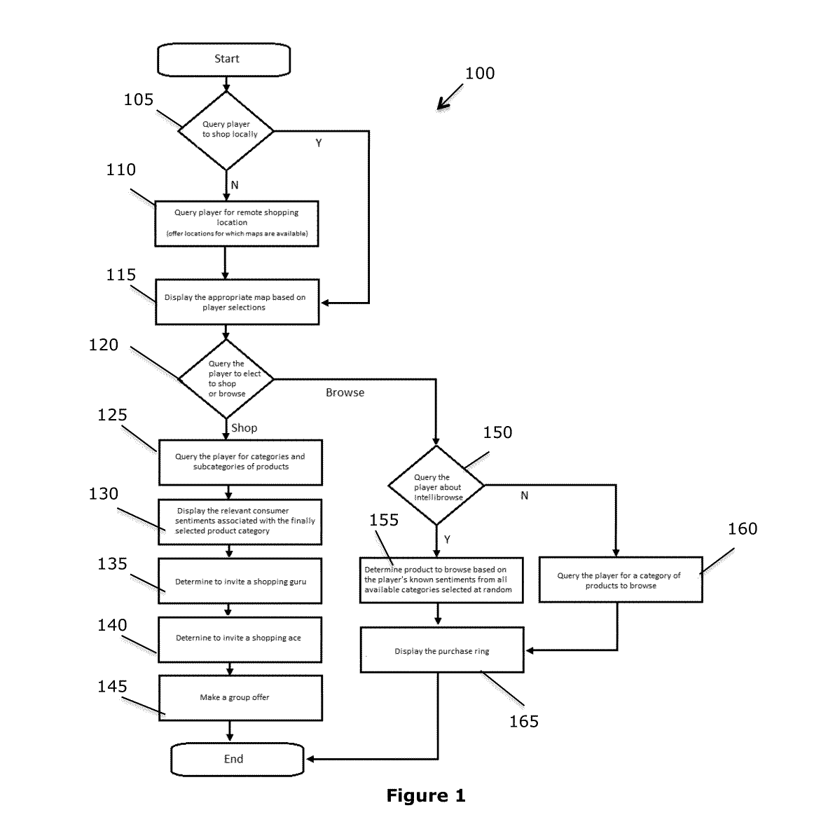

FIG. 1 conceptually illustrates a process 100 of some embodiments for shopping for in-game assets using an online social game interface. Process 100 will be described by reference to FIGS. 2-12 which illustrate some embodiments of an example shopping game interface in which a first player shops for an in-game asset.

FIG. 2 illustrates an example game interface 205 that some embodiments of the invention automatically generate and display when a first player connects to the game server through a social networking website. FIG. 2 includes a first player graphical representation 210, a Friends List 235 that may be automatically generated from the first player's network of friends on the social network website, an Instant Messaging Platform 240, a list of Game Command Buttons 245, and a graphical user interface (“GUI”) 250. In some embodiments, GUI 250 is dynamic, meaning it changes based on first player inputs.

Returning to FIG. 1, the process 100 begins when the process (at 105 and 110) generates a prompt to the first player. In the example shown in FIG. 2, GUI 250 presents a shopping location prompt to the first player from the game server. The prompt may be automatically generated from the game server and may appear in GUI 250 as a graphical representation 215. In some embodiments, the first player is also presented with input buttons to communicate with the game server, illustrated in the example in FIG. 2 as shop Local button 220 and shop Global button 225.

In some embodiments, a first player selection of shop Global button 225 further reveals GUI 230, which may include additional first player input buttons. In the example in FIG. 2, four additional input buttons are displayed for global cities (e.g., Madrid, Paris, New York, London, etc.). In some embodiments the game server may determine a first player's location using GPS technology. In other embodiments, the game server may determine a first player's location by utilizing the first player computer's IP address to display corresponding local or global city map interfaces.

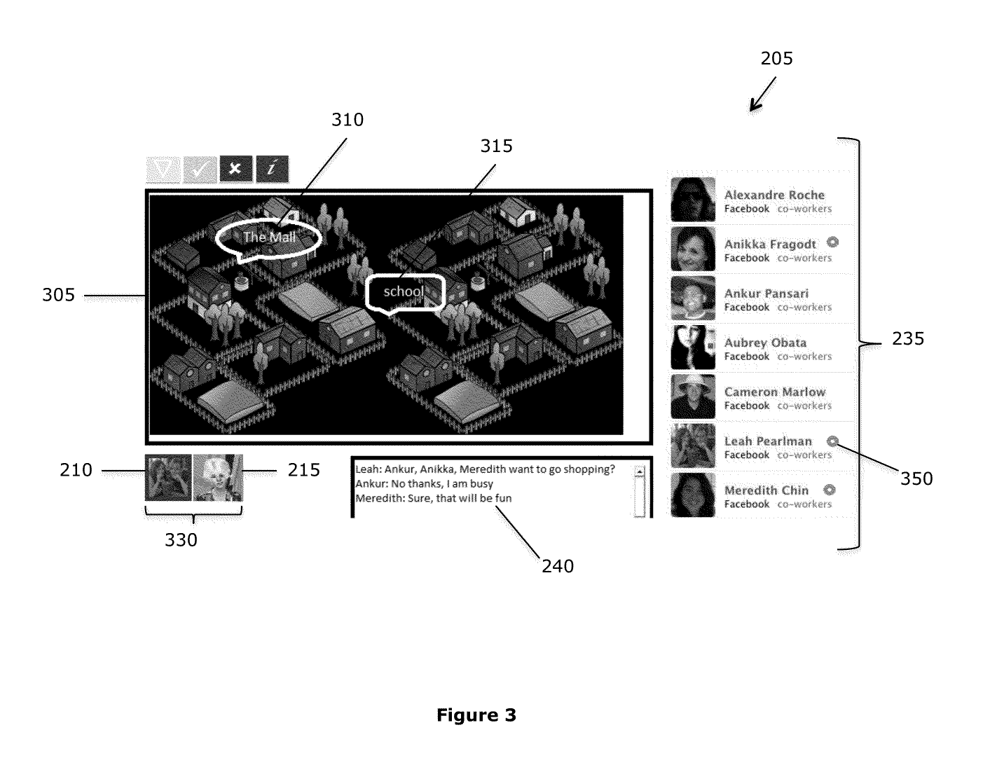

FIG. 3 illustrates an example game interface 205 after the first player selects shop Local button 220. The selection of shop Local button 220 displays GUI 305. In the example of FIG. 3, GUI 305 illustrates a virtual city map with various game structures that include Mall 310 and School 315. In some embodiments, the virtual city map is a graphical representation of the first player's actual local city, and the game structures are graphical representations of real structures in the first player's actual local city. One of ordinary skill in the art will understand that various other structures may be represented in GUI 305 (e.g., Stadium, Supermarket, Beauty Salon, etc.).

In some embodiments, real structures that are 3^{rd} party affiliates of the social game are represented in the virtual city map. For example, a local Macy's Department store can choose to become a third party affiliate of the social game and be represented by a game structure such as Mall 310 in a first player's local virtual city map. By clicking on said game structure, the first player can essentially go shopping at the local Macy's Department Store within the social game context. In other words, the virtual in-game assets displayed in Mall 310 may correspond to actual inventory of goods located in the local Macy's Department Store in this example. In another example, if a first player lives in New York City and chooses to shop globally (e.g., in Paris), and clicks on a Mall game structure in the virtual city displayed, the first player may shop for in-game assets that are found in an actual Department Store in Paris.

In some embodiments, the first player can invite one or more second players from their Friends List 235 to shop with them if they are logged into the game system, as illustrated by an online status indicator 350. In some embodiments, a first player can invite one or more online second players to view the first player's game interface 205 using the Instant Messaging Platform 240. All players who are viewing the first player's game interface 205 show up as a graphical representation in View List 330 and are defined as Active Players.

In some embodiments of the online social game, the goal is to build up a player's character state. Players build up character state by amassing in-game assets. In some embodiments, the game server manages and directs the first player for shopping for an in-game asset.

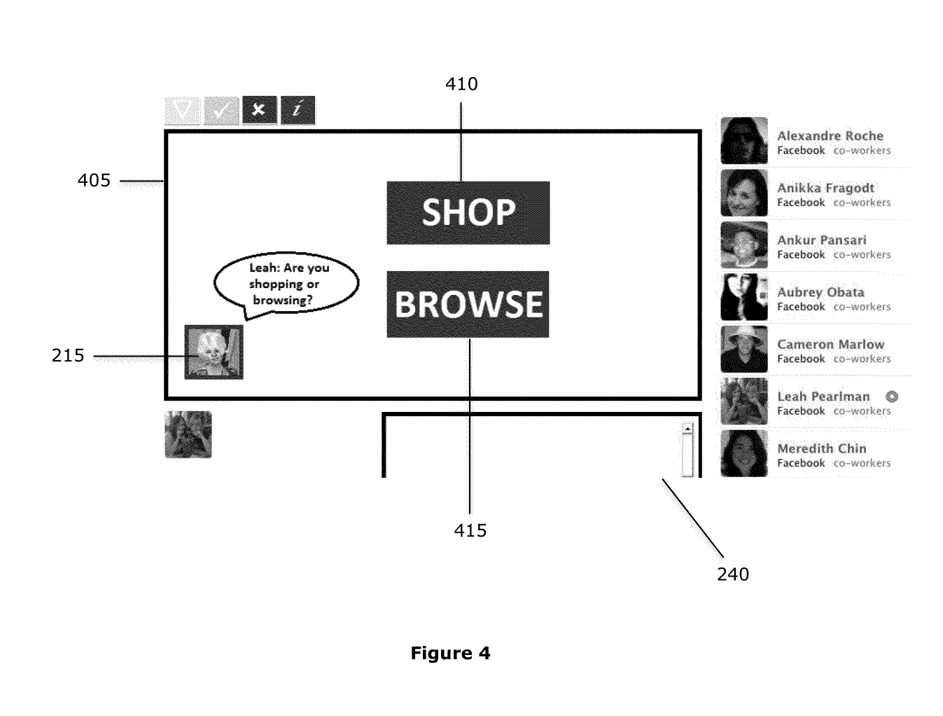

Returning to FIG. 1, after the process receives (at 115) a first player input to determine shopping location, it then prompts the first player (at 120) whether the first player would like to shop or browse for in-game assets. In the example of FIG. 4, the first player arrives at GUI 405 by selecting Mall structure 310 from GUI 305 in FIG. 3. In some embodiments, graphical representation 215 may prompt the first player to select either Shop button 410 or Browse button 415 in GUI 405.

In some embodiments, the purpose of prompting the first player (at 120) in process 100 is to communicate to the game server what types of in-game assets to present to the first player and the manner in which to present said in-game assets. Several more detailed embodiments are described in the sections below. Section A further describes a method for presenting in-game asset options to a first player based on input from Active Players. Section B further describes a method for presenting in-game asset options to a first player based on computer generated suggestions.

A. Targeted Shopping

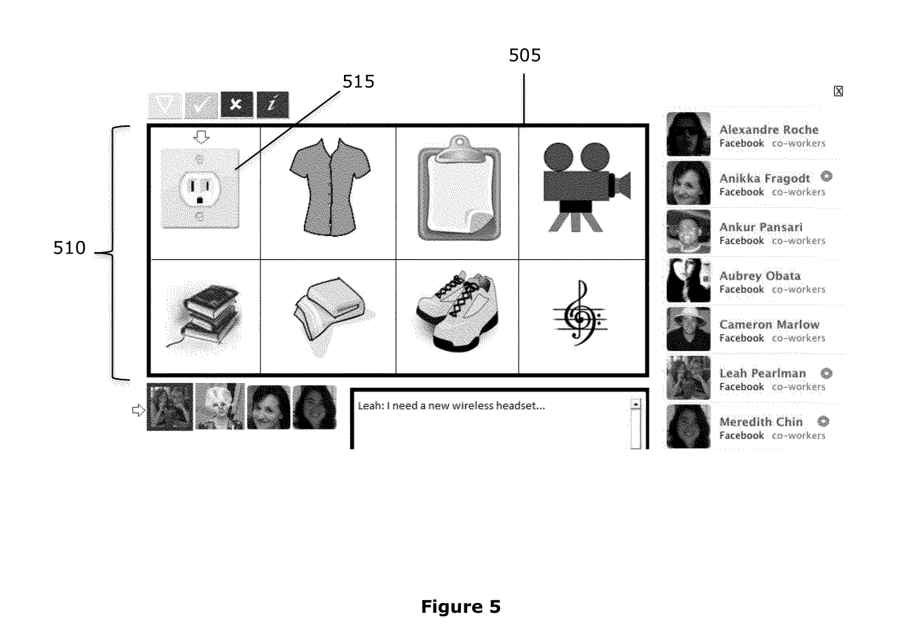

Returning to FIG. 1, once the first player has selected Shop button 410 as shown in FIG. 4, the process (at 125) presents the first user with category options and subsequent subcategory options based on a series of first player selections. In the example illustrated in FIG. 5, the first player arrives at GUI 505 by selecting Shop button 410. In some embodiments, GUI 505 displays category options 510. The category options displayed may be based on the inventory of in-game assets associated with the game structure previously selected. For example and not by limitation, if Mall structure 310 in FIG. 3 is a Macy's Department Store, the category options displayed in GUI 505 would be a true virtual representation of the real goods contained in the inventory at the real Macy's Department Store.

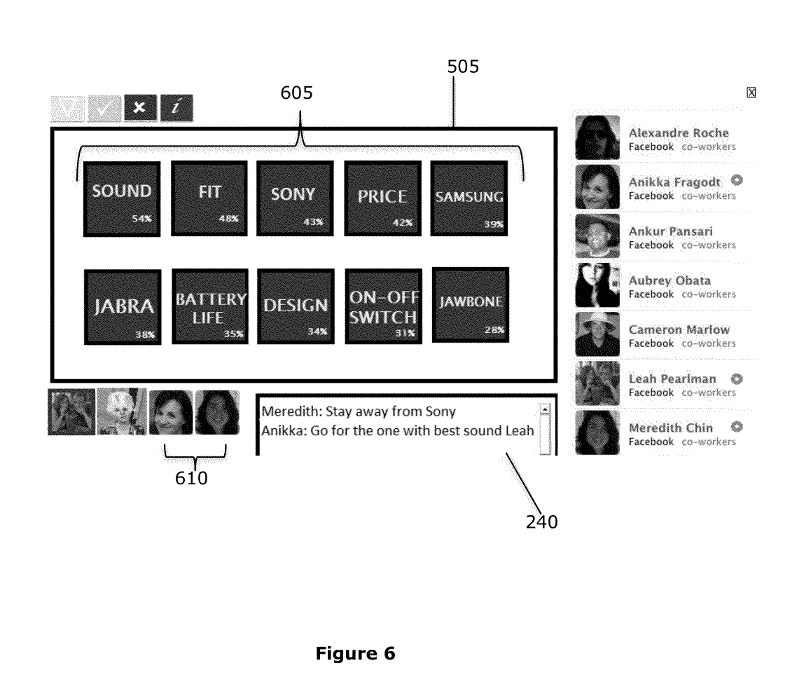

In the example illustrated in FIG. 5 a first player is searching for a specific type of in-game asset. The first player is presented with all category options 510 in the selected game structure. FIG. 6 illustrates GUI 505 once a category 515 and one or more related subcategories are selected. Subcategory options 605 that include relates to said in-game asset options.

Returning to FIG. 1, the process (at 130) determines if there are relevant consumer sentiments associated with the in-game asset options displayed after a final subcategory is selected by the first player from subcategory options list 605. In some embodiments, the process (at 130) suggests specific in-game asset options based on relevant consumer sentiments that the first player selects as important.

In some embodiments, other Active Players may communicate with the first player using the Instant Messaging Platform 240 when they are displayed in View List 330. In the example shown in FIG. 6, Active Players 610 use Instant Messaging Platform 240 to communicate their views on subcategory options 605.

Returning to FIG. 1, the process (at 135 and at 140) determines whether or not assistance is needed from Special Players to select an in-game asset. In some embodiments, Special Players may include but are not limited to Shopping Gurus, Shopping Aces, Shopping Connoisseurs, and a machine driven software agent.

The process (at 135) is initiated when a request has been received from a first player for assistance from players that have reached a certain level of shopping expertise. In some embodiments, these players are Special Players who may be referred to as “Shopping Gurus.” Shopping Gurus may be online players who are not in the first player's Friends List 235 but are willing to be interrupted in their own game play to give advice to players outside of their own Friends List 235. In some embodiments, the game server may identify Shopping Gurus as players who have attained a pre-determined character state level.

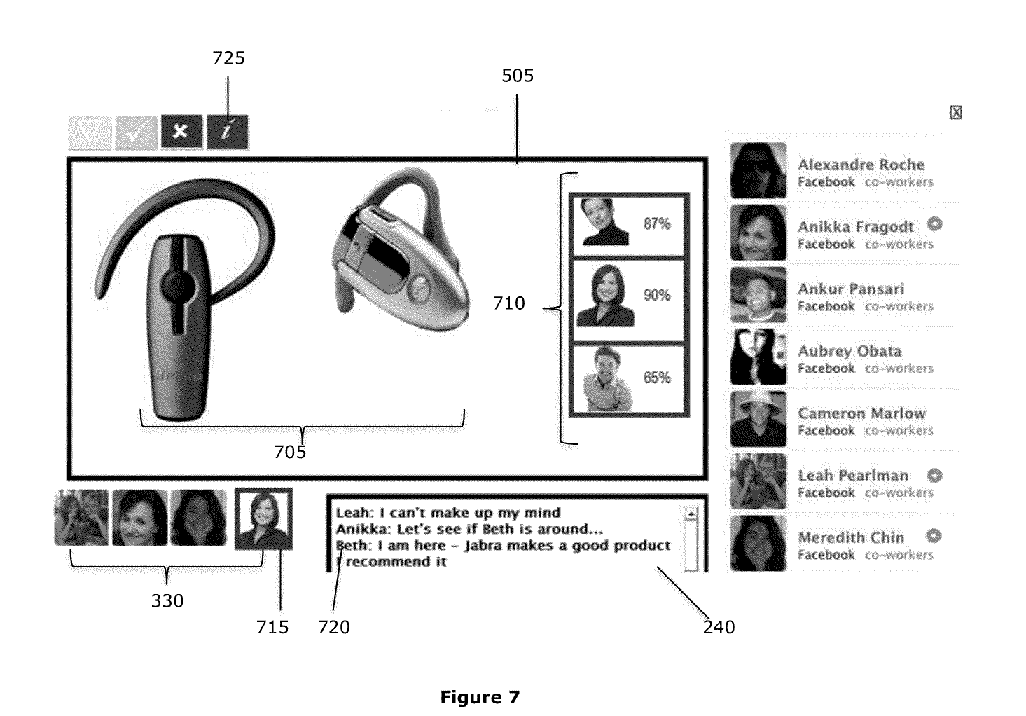

FIG. 7 illustrates an example GUI 505 that displays two in-game asset options 705. The first player can request assistance from a Special Player by selecting help button 725. In some embodiments, selecting help button 725 displays GUI 710. GUI 710 presents a list of Special Players who have achieved Shopping Guru status and are online. The first player can select one of the presented Shopping Gurus who, once selected, will be displayed as graphical representation 715 in the first player's View List 330 and becomes an Active Player who can communicate with all Active Players in List View 330 using Instant Messaging Platform 240. In the example illustrated in FIG. 7, a Shopping Guru, Beth, recommends one specific in-game asset to help the first player decide which in-game asset to select.

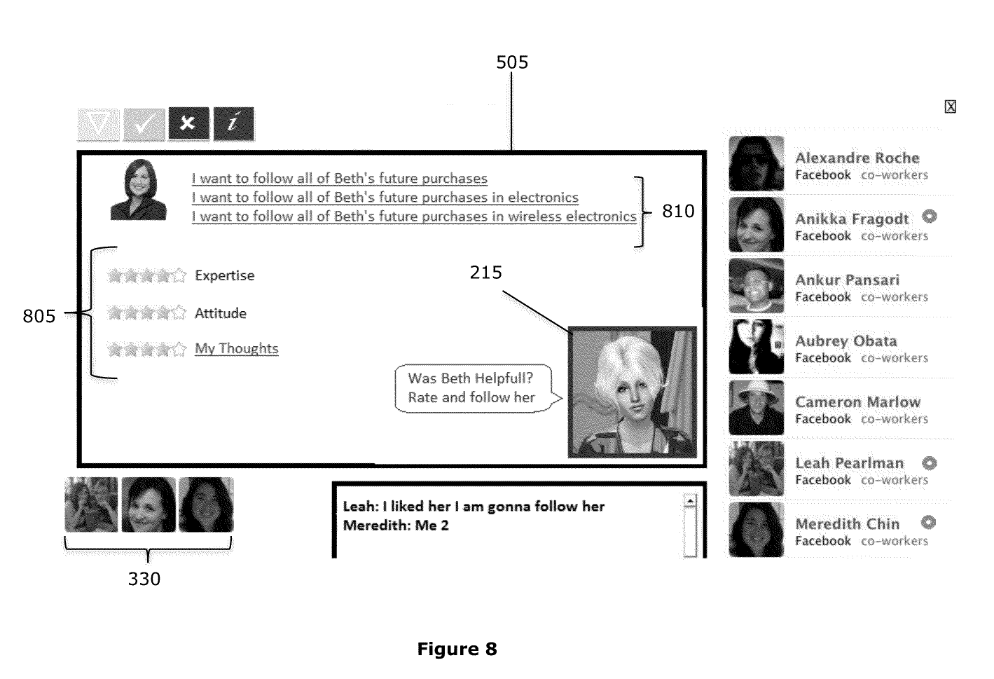

FIG. 8 illustrates some embodiments of GUI 505 once the Shopping Guru is no longer an Active Player in View List 330. In some embodiments, the first player can rate the Shopping Guru using Rating Tools 805. In other embodiments, the first player can request to follow and set parameters for following said Shopping Guru using Follow Tools 810. For example, the first player can decide to follow and view all of said Shopping Guru's future purchase, follow and view all of said Shopping Guru's future purchases in a related subcategory, or follow and view all of said Shopping Guru's future purchases in a related category.

The process (at 140) is initiated when the process determines that a computer generated Special Player can assist a first player in selecting an in-game asset. In some embodiments, said computer generated Special Player may be referred to as a “Shopping Ace.” Said Shopping Ace may be a computer generated graphical representation who can communicate with players in a similar manner as graphical representation 215.

An example of real people who may reach a Special Player status of Shopping Ace and be given a computer automated digital personality are individuals who have an established following on other online platforms (e.g., YouTube, Twitter, etc.) or Shopping Gurus that have gained a predetermined level of recognition through other player ratings or following in the social game. In this way, all players of the social game can strive to become Shopping Gurus and ultimately Shopping Aces.

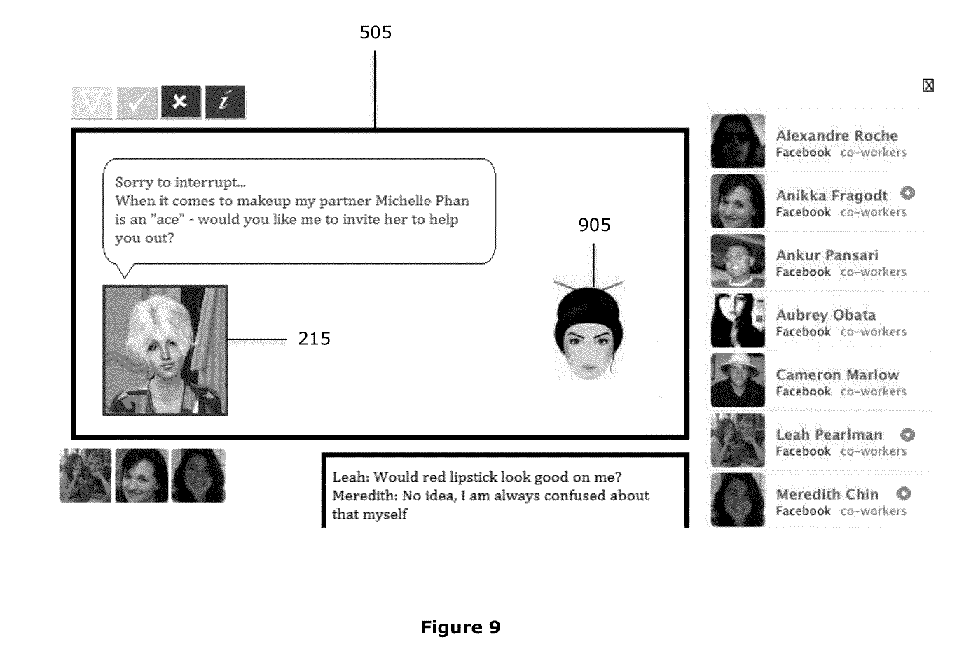

FIG. 9 illustrates an example GUI 505 where a prompt to invite a Shopping Ace may be automatically generated from the game server and appear in GUI 505 through graphical representation 215. In some embodiments, the game server can initiate a request for a first user to communicate with a Shopping Ace based on a computer generated algorithm that takes into account the first player's sentiments along with those of all other players in the social game and the marketplace. Upon receiving the first player's selection, a graphical representation of the computer recommended Shopping Ace 905 is displayed in GUI 505. In some embodiments, Shopping Ace 905 can communicate with a first player and other Active Players through computer generated prompts and responses similar to graphical representation 215 and assist the first player to select an in-game asset.

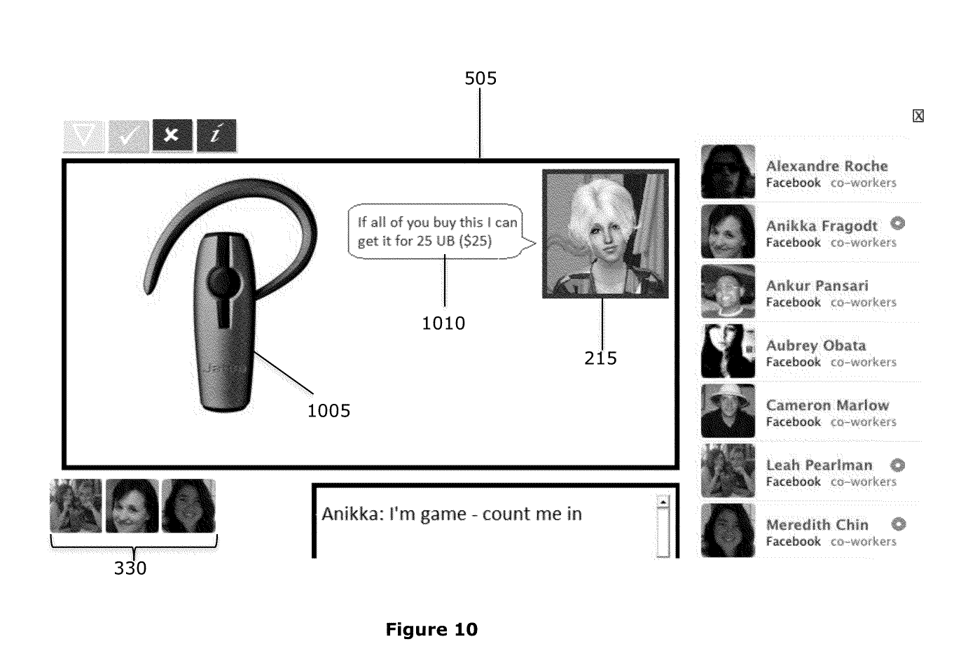

Returning to FIG. 1, the process (at 145) may be initiated when a first player makes a selection of an in-game asset and before the first player has tendered the associated cost to complete the selection of said in-game asset. In some embodiments, the associated cost of an in-game asset may be the same value as the actual cost of the corresponding real good or service. However, only virtual currency may be used to purchase an in-game asset. In some embodiments, players may earn virtual currency by completing in-game activities or through purchase deal offers. In some embodiments, after having purchased an in-game asset, a player has the option to purchase the corresponding real good or service. By doing so, the player earns more virtual currency, which is offered by the retailer as an incentive to move the real good or service. The process (at 145) can be illustrated with reference to the example in FIG. 10. Upon selecting an in-game asset, GUI 505 displays the graphical representation of the in-game asset 1005. In some embodiments, the game server may identify in-game assets that qualify for a purchase deal and present it to Active Players through communication using graphical representation 215 in GUI 505.

In the example of FIG. 10, the process has identified a purchase deal in the form of group offer 1010. Group offer 1010 lowers the associated cost to purchase in-game asset 1005 if all of the Active Players in View List 330 agree to purchase in-game asset 1005. In some embodiments, the decrease in associated cost is directly proportional to the number of Active Players involved. The greater the number of Active Players in the group, the greater the discount offered will be. In some embodiments, as illustrated in the example of FIG. 10, the actual cost of the corresponding real good or service in a group offer may also be decreased proportionally if simultaneously purchased as part of a group offer incentive.

Returning to FIG. 1, process 100 ends once a first player selects an in-game asset and tenders the associated selection cost using virtual currency. In some embodiments, a graphical representation of the purchased in-game asset is stored in the first player's virtual storage room. A first player may rearrange the in-game assets in the virtual storage room to communicate various sentiments. As an example, a first player may place an in-game asset on a table in the virtual storage room to signify that the corresponding real good or service is desired as a gift.

B. Browse Shopping

Returning to FIG. 1, once a first player has selected Browse button 415 as shown in FIG. 4, the process (at 150) identifies how the first player would like to browse in-game assets options. In some embodiments of the invention, there are three different browsing mechanisms that are available to the first user: Randomized Browse, Category Browse, and Targeted Browse.

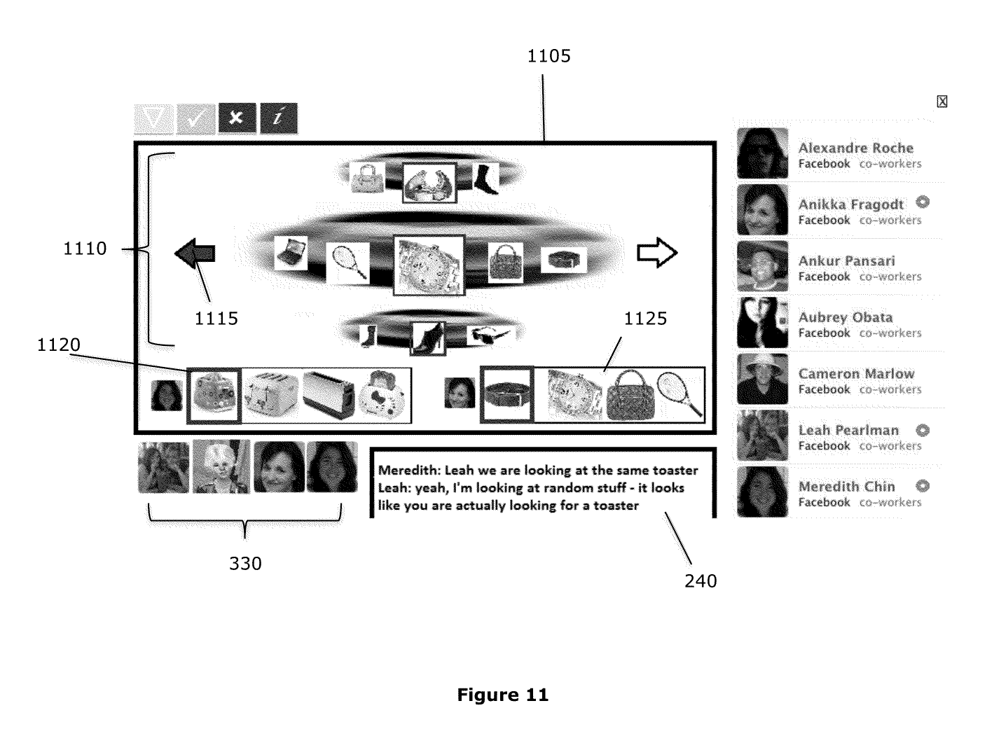

In some embodiments, upon receiving a first player request to enable Randomized Browse, the process (at 155) determines which in-game assets in the game server's product data storage are preferred based on stored first player data and automatically displays all of said in-game assets to the first user. As an example and not by limitation, the game server may determine in-game assets options the first player may want to purchase based on already purchased in-game assets, purchased real goods and services, how much virtual currency the first player has and prior sentiments expressed by first player. In some embodiments, this particular mechanism utilizing randomized browsing of computer-generated suggestions is called “Intellibrowse.” FIG. 11 illustrates an example Randomized Browse Display 1110. The example displays all types of in-game assets, including but not limited to a watch, a purse, a tennis racket and a laptop.

In some embodiments, upon receiving a first player request to enable Category Browse, the process (at 160) may automatically generate a prompt from the game server to be displayed in GUI 405 as a graphical representation 215, and request the first player to select a category of in-game assets. In some embodiments, all in-game assets in the game server's product data storage that fall within the selected category may be displayed. In other embodiments, only in-game assets within the selected category that the game server determines to be preferred by the first player may be displayed. FIG. 11 illustrates an example Category Browse Display 1125. The example displays all in-game assets that fall under the category of luxury goods, including but not limited to a designer watch, a designer purse, and a designer belt.

In some embodiments, upon receiving a first player request to enable Targeted Browse, the process (at 160) may automatically generate one or more prompts from the game server to be displayed in GUI 405 as a graphical representation 215, and request the first player to select one or more of a category and subsequent subcategories to choose a specific subcategory of in-game assets. In some embodiments, all in-game assets in the game server's product data storage that fall within the specific subcategory may be displayed. In other embodiments, only in-game assets within the specific subcategory category that the game server determines to be preferred by the first player may be displayed. FIG. 11 illustrates an example Targeted Browse Display 1120. The example only displays in-game assets, which fall under the specific subcategory of toasters, and include different toaster models.

FIG. 11 illustrates how the in-game asset options generated by the game server are displayed to a first player. In some embodiments, FIG. 11 includes GUI 1105, the first player's Randomized Browse display 1110, Scroll button 1115 to sequentially move through the display, View List 330 which shows Active Players who are also browsing, Active Player One's Targeted Browse Display 1120, Active Player Two's Category Browse Display 1125, and Instant Messaging Platform 240.

In some embodiments, by default, the first player's in-game asset options display 1110 is in the primary position within GUI 1105. In the example shown in FIG. 11, the primary display consists of all the in-game assets organized on three rings, and the in-game assets within each ring moves cyclically in sequential order. The three are situated so that the ring in the middle is at eye level on the screen and contains the in-game assets determined to be most preferred by the first user. One ring is situated above the middle ring, slightly above eye level, and one ring is situated below the middle ring, slightly below eye level. In some embodiments, a Scroll button 1115 may require selection by the first player to sequentially move the display cyclically. In other embodiments, the display may automatically move in a cyclical motion and present all in-game asset options sequentially.

In some embodiments, any display not in the primary position in GUI 1105, illustrated by example in FIG. 11 as Targeted Browse Display 1120 and Category Browse Display 1125, only the in-game asset options included in the middle ring of a primary display are shown. In some embodiments, the display moves linearly in a bar display as illustrated in the example of FIG. 11. In some other embodiments, the display may maintain its 3-D cyclical ring formation.

In some embodiments, GUI 1105 is dynamic and allows a first player to change which display is in the primary position. For example, in FIG. 11, the first user can click on Targeted Display 1120 to move it to the primary position and view the in-game assets in the primary view 3 ring formation.

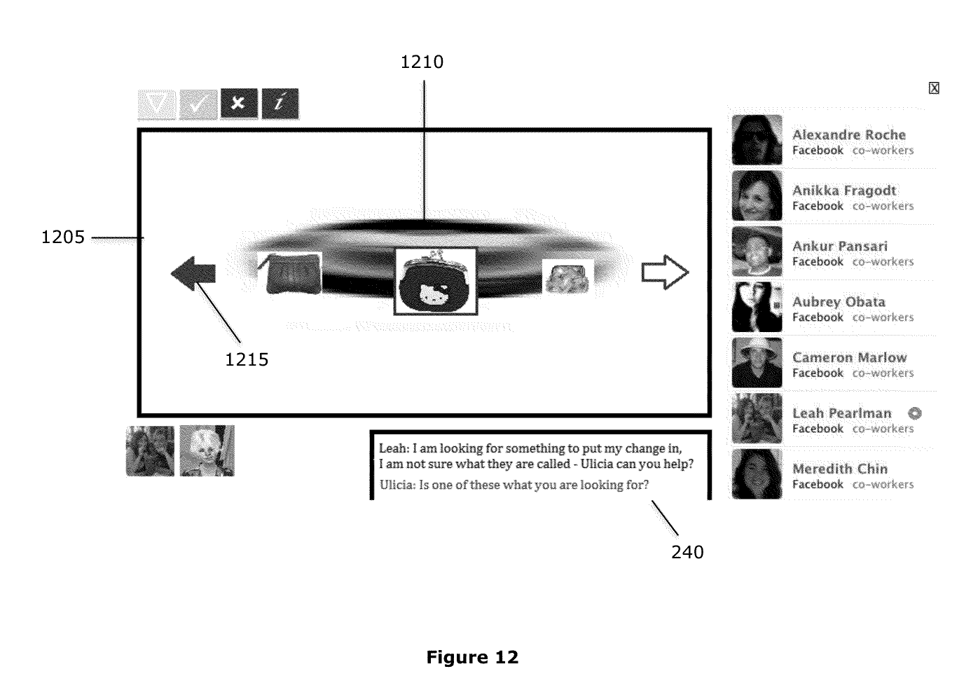

FIG. 12 illustrates another way that a first player can utilize the game server to help find in-game assets when the first player does not know exactly what to search for. In the example in FIG. 12, the first player may want to know if there are any in-game assets that even exist to fit certain functionality desired by the first player. The first player may communicate the request to the game server by inputting the query in Instant Messaging Platform 240. In some embodiments, the game server will search the product data storage for any in-game assets that may fit the query and display them in GUI 1205 on a singular ring 1210 with Scroll button 1215.

The examples given in FIG. 11-12 are merely examples and not exhaustive as to how to display in-game assets for browsing. One of ordinary skill in the art will realize that there are many different configurations that can be used to display in-game assets, and the invention is not limited to the embodiments set forth.

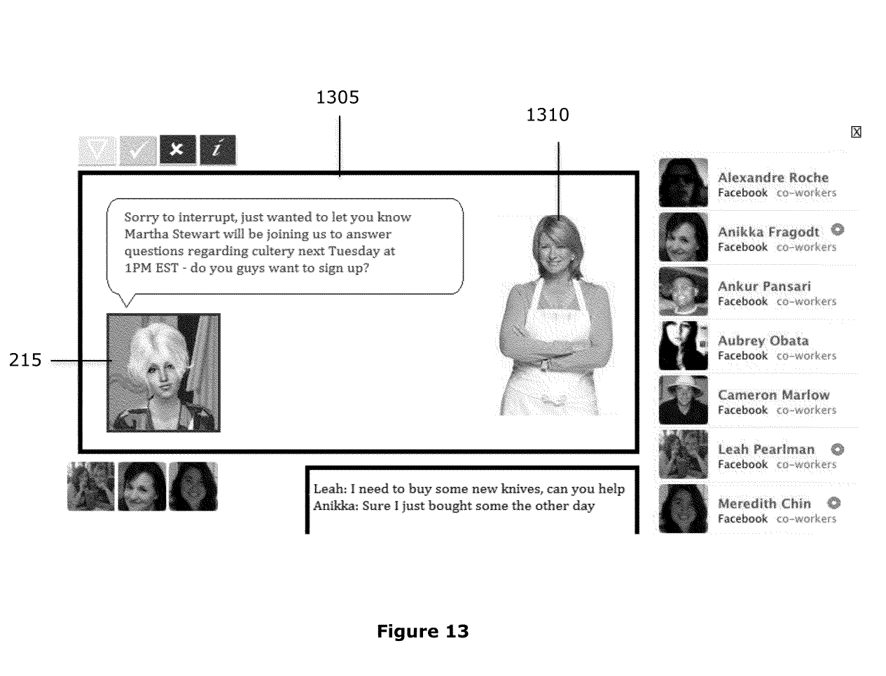

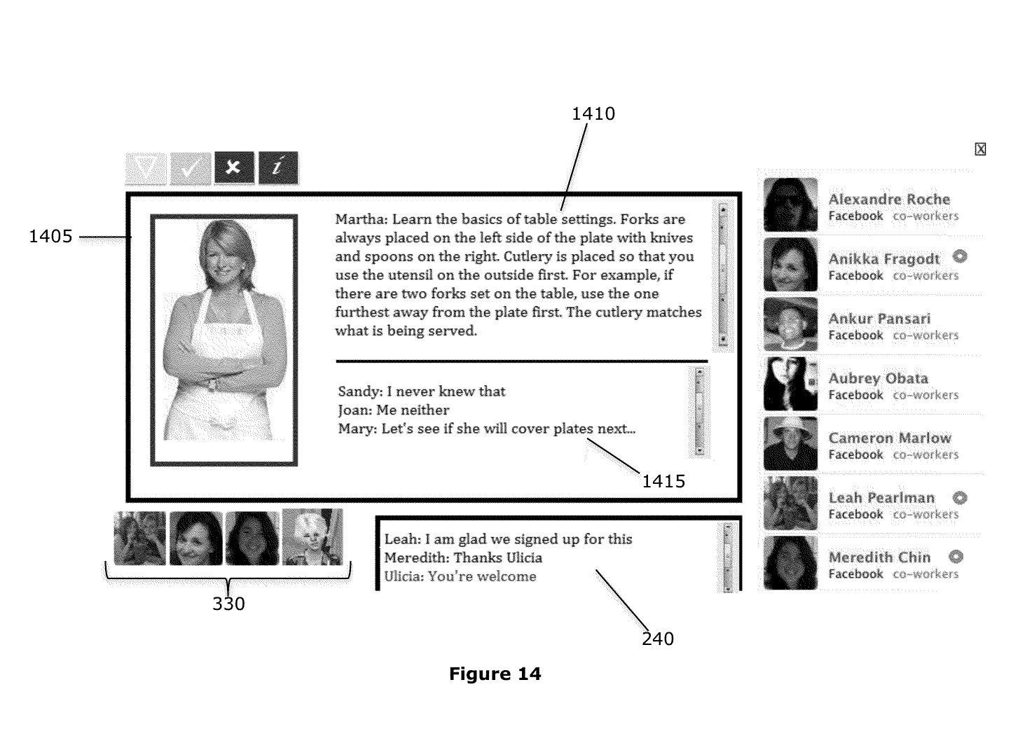

In some embodiments, Special Players also can assist a first player in shopping for in-game assets. FIGS. 13-14 illustrate an example where a Special Player known as a Shopping Connoisseur is assisting groups of players. In some embodiments, a Shopping Connoisseur is someone who is recognized as a celebrity in their field of expertise (e.g., Martha Stewart, Rachel Zoe, etc.) and not a level that is attainable by the majority of players in the example online social game described here.

In some embodiments, the game server determines that many players have questions or are interested in a topic that can include but is not limited to how to choose an in-game asset, how to use an in-game asset, etc. In some embodiments, the game server may automatically determine the common need for assistance through players' sentiment, communications with each other, the game server, and other Special Players (e.g., Shopping Guru, Shopping Ace), among other information contained in player data storage. In some embodiments, the game server will request a Shopping Connoisseur to organize a multicast to address the identified issue or concern.

In the example of FIG. 13, a prompt may be automatically generated from the game server and may appear in GUI 1305 as a graphical representation 215 after a Shopping Connoisseur schedules a multicast. One of ordinary skill in the art will appreciate that other interfaces may be used to bring a group of people together for discussion other than a multicast. In some embodiments, this prompt may be automatically generated to all players who have expressed any sentiment regarding the scheduled topic, alerting them of the scheduled date and asking players to sign up. In some embodiments, a Shopping Connoisseur graphical representation 1310 is also displayed in GUI 1305.

FIG. 14 illustrates an example multicast hosted by a Shopping Connoisseur. In some embodiments, GUI 1405 is split into Instant Messaging Platform 1410 and Instant Messaging Platform 1415. In some embodiments, the Shopping Connoisseur communicates with all players attending the multicast by inputting comments into Instant Messaging Platform 1415. View list 330 may show Active Players that are also attending the live multicast. In some embodiments, the first player can communicate only with Active Players attending the multicast using Instant Messaging Platform 240. In some embodiments, Instant Messaging Platform 1415 shows all communications from every player attending the multicast, regardless of whether they are in your friend network on the social networking website.

II. Incentives for Shopping Through Social Game Interface

There are a variety of in-game activities that a first player can play with one or more second players that are illustrated in the below example embodiments of an online shopping social game. In some embodiments, the in-game activities generally fall into two categories: computer generated Mini-Games and user generated Quests.

A. Mini Games

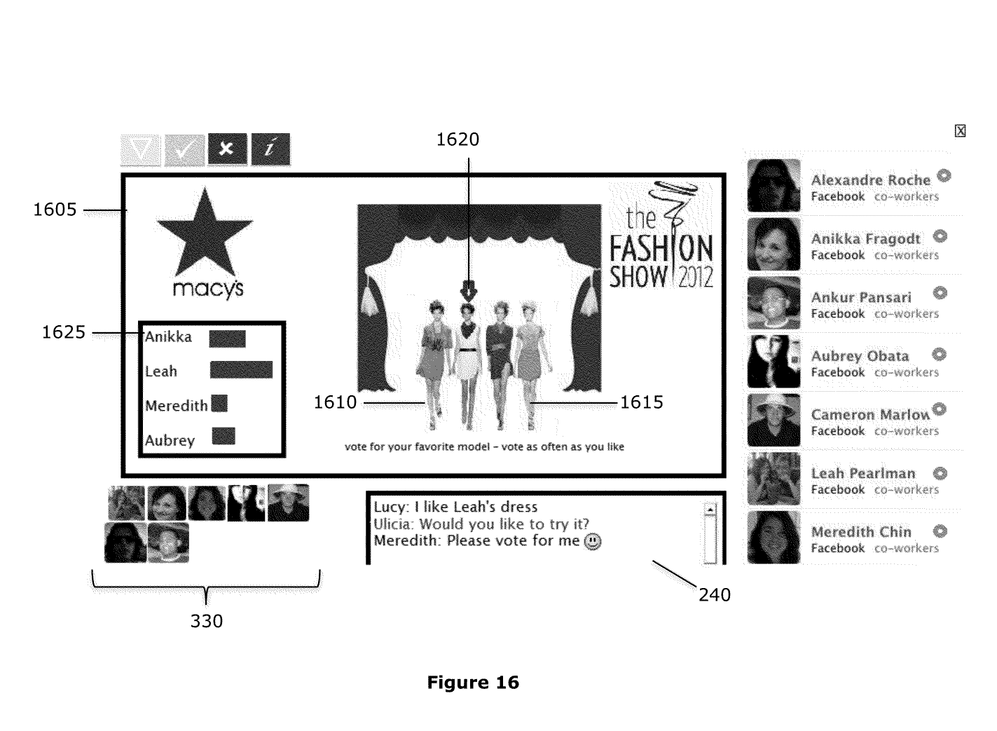

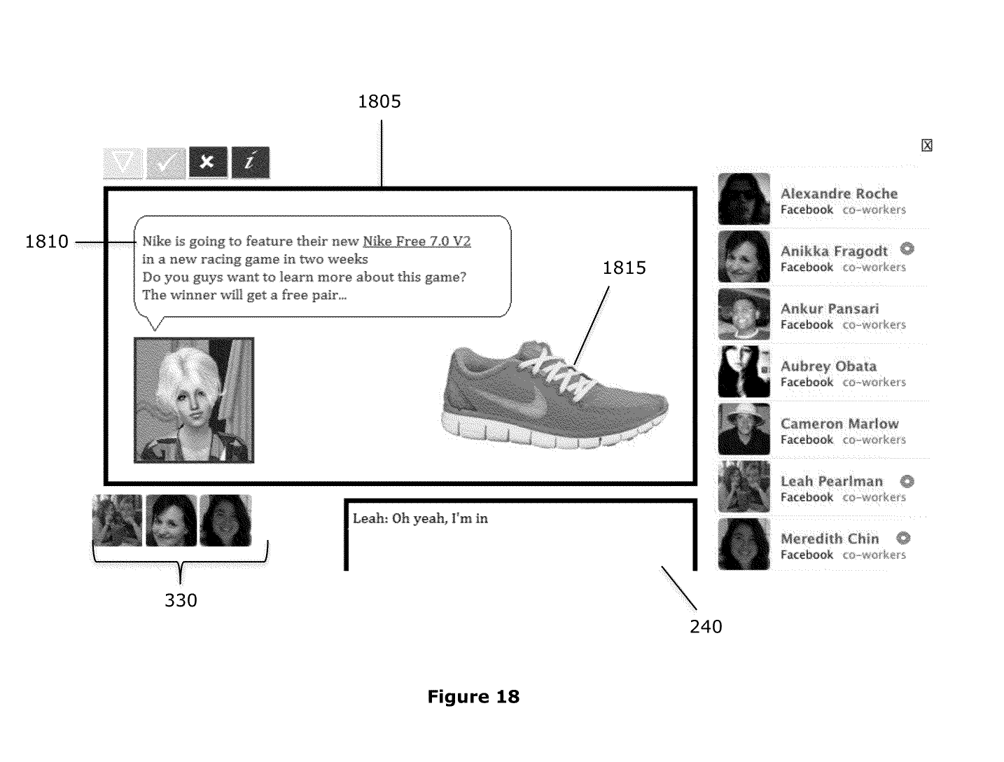

In the example social game described here, Mini games are computer generated in-game activities. In some embodiments, mini games can incentivize players to shop because possession of certain in-game assets may be required to play some mini games, as illustrated in the example of FIG. 16 below, or may give a first player an advantage in a mini game, as illustrated in the example of FIGS. 18-21.

Returning to the virtual city illustrated in FIG. 3, each game structure on the map may be associated with shopping, one or more mini games, or both shopping and mini games. For example, if a first player clicks game structure School 315, the first player may be prompted to play a mini game related to the depicted local school such as an education related game with a shopping theme. For example, School 315 could be a fashion school that is sponsoring a fashion show mini game to teach how to match and style outfits. FIG. 16 below illustrates this example game in more detail. In some embodiments, the first user may also click on game structure School 315 and be prompted to go shopping for in-game assets from that local school's patron store.

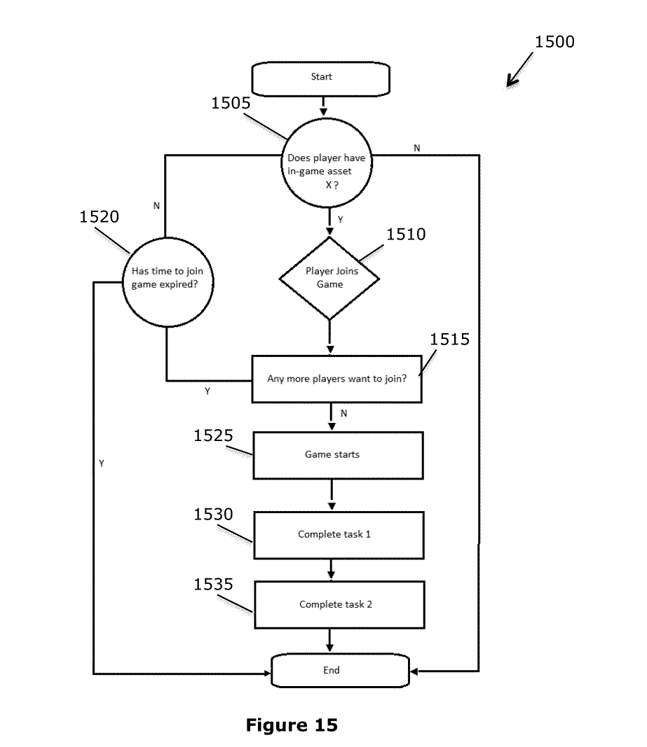

FIG. 15 conceptually illustrates a process 1500 of some embodiments for playing a mini game that requires possession of a specific in-game asset to join. Process 1500 will be described by reference to FIG. 16. Process 1500 begins when a player requests to join the game. The process (at 1505) determines if the player has a specific in-game asset X. If the player has in-game asset X the process (at 1510) permits the player to join. Then the process determines if any more players are requesting to join the game. If the process (at 1515) receives a request to join the game from another player, the process (at 1520) determines if the time given to join the game has expired. If not, the process (at 1505) determines if the new player has a specific in-game asset X. If so, the second player is also permitted to join. These process steps may repeat until the time to join the game has expired or no additional players want to join. In some embodiments, there may also be a predetermined number of players that are allowed to join a mini game.

In the example of FIG. 16, GUI 1605 shows the different components that make up this mini game. A first player has joined three other players in the mini-game before time to join expired. The graphical representation of the first player is wearing in-game asset 1610, specifically sandals, which are required to join the fashion show game. List View 330 shows all players who are in the mini-game. In some embodiments, only players who have joined the process may create and model outfits.

Returning to FIG. 15, the process (at 1525) begins the game and the process (at 1530) prompts players to start task 1. After the process receives indication that players have completed task 1, the process (at 1535) prompts players to complete task 2. The process ends upon completion of task 2.

Returning to the example of FIG. 16, the task 1 may be to put together an outfit using any of your in-game assets to style with the required in-game asset 1610. In some embodiments, each player selects in-game assets they possess to create an outfit 1615. Once all players have finished, the mini game may prompt each player to model their outfit on a runway for task 2 after which the game process ends.

In some embodiments, players who are unable to join a mini-game can still be viewers of the game. In some embodiments, viewers are allowed to take part in mini-games. In the example of FIG. 16, the mini game prompts viewers in View List 330 to vote for their favorite outfits. In some embodiments, a viewer may vote for their favorite outfit by clicking on a Selection button 1620. Players in View List 330 can communicate to one another using Instant Messaging Platform 240. In the example of FIG. 16, GUI 1625 displays a graph view that shows which player has the most votes. Upon termination of the game, the player with the most votes wins. In some embodiments, a mini game will have pre-determined rewards. Examples of mini-game rewards include but are not limited to virtual currency, in-game assets, real currency, or real goods and services.

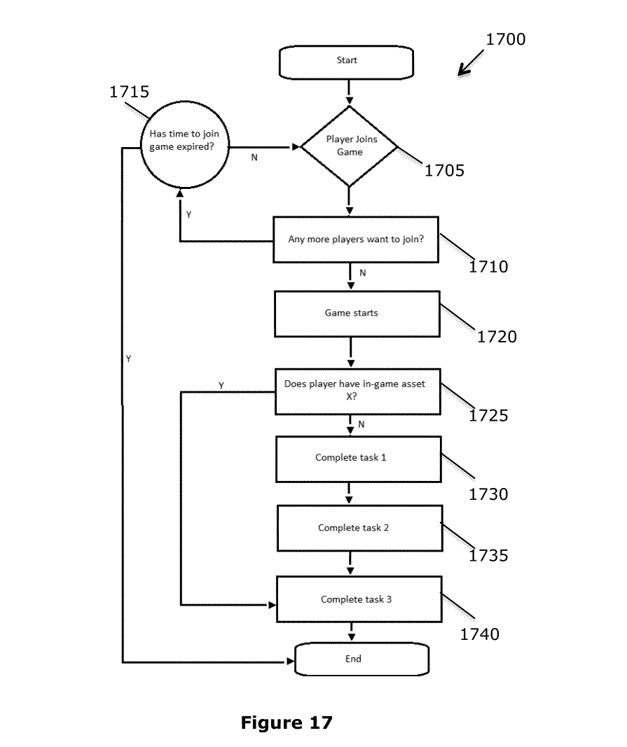

FIG. 17 conceptually illustrates a process 1700 of some embodiments for playing a mini game where possession of a specific in-game asset provides utility in the game to help you get ahead. Process 1700 will be described by reference to FIGS. 18-21. Process 1700 begins when the process receives (at 1705) a player request to join the game. Then the process determines (1710) whether additional players want to join. If so, additional players can keep joining until the process determines (at 1715) that the time to join the game has expired.

The example of FIG. 18 illustrates a sports related mini-game sponsored by Nike to promote a new shoe design. In some embodiments, a player may request to join the game by selecting an example stadium game structure from the virtual city in FIG. 3. Example GUI 1805 may explain to a first player the rules of the mini game, whether any specific in-game assets are required or beneficial, here illustrated by graphical representation of Nike shoe 1815, and any reward for winning the game. This information can help a first player decide whether or not to join the game.

Returning to FIG. 17, the process (at 1720) starts the game when the time to join has expired or no more players want to join. Once the game has been started, the process (at 1725) identifies if a player has a specific in-game asset. If so, the process may prompt player to go to complete the final task 3 in the process (at 1740). If the process (at 1725) receives no indication that a player has a specific in-game asset, the process (at 1730) prompts said player to complete task 1, and the process (at 1735) prompts said player to complete task 2, before the process (at 1740) prompts the player to complete the final task 3 of the mini-game.

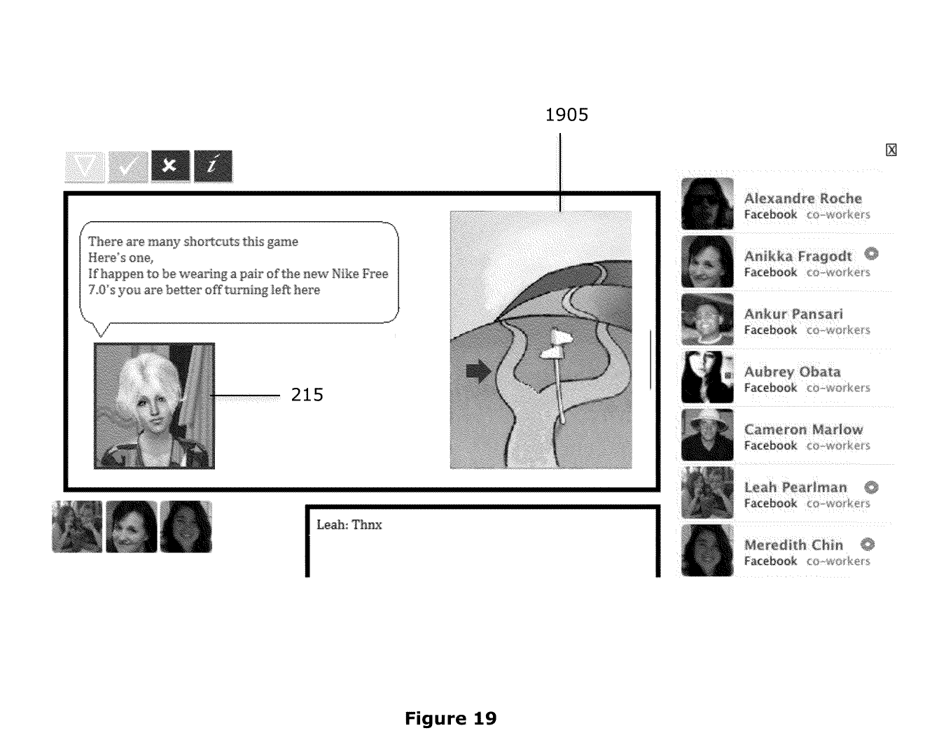

FIG. 19 illustrates an example where the graphical representation 215 prompts a player who is wearing Nike shoe 1815 on the correct shortcut during the first task in the race, illustrated in FIG. 19 as choosing which path to take in GUI 1905. In some embodiments, players in the race who do not possess the in-game asset of Nike shoe 1815 do not receive a prompt for the correct shortcut route.

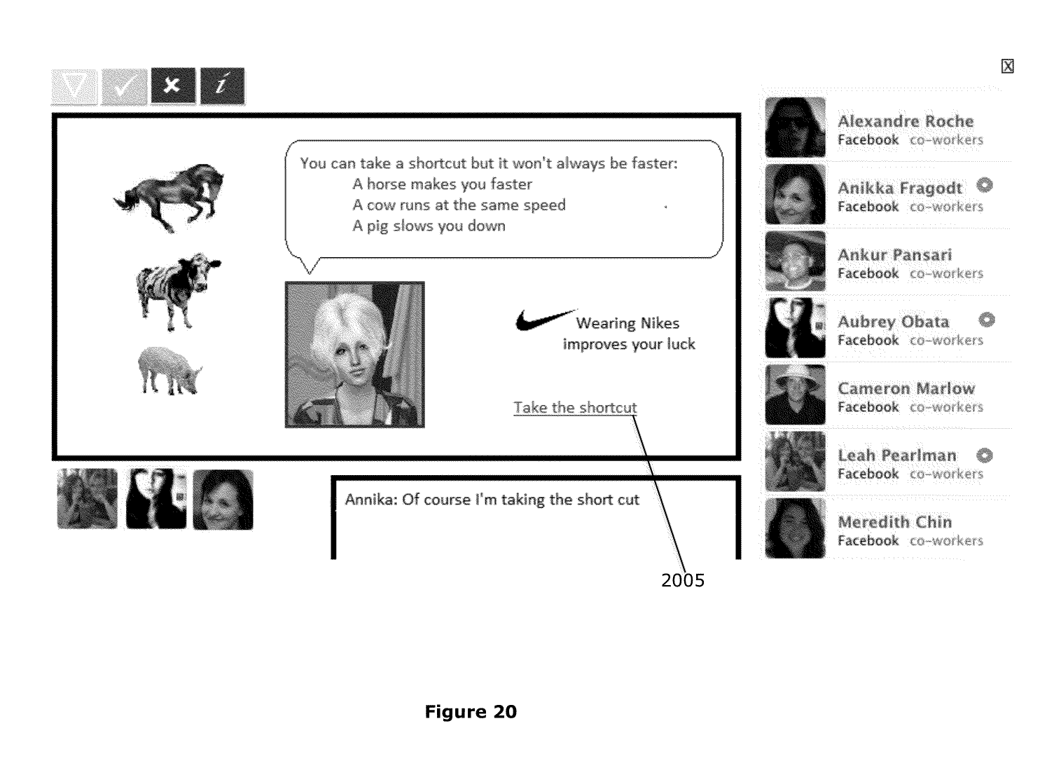

FIG. 20 illustrates a process that prompts players to take a second shortcut by selecting Take Shortcut command 2005. In some embodiments, if a player is wearing Nike shoe 1815, the probability that the player completes the task faster increases, and gives the player a better chance to win.

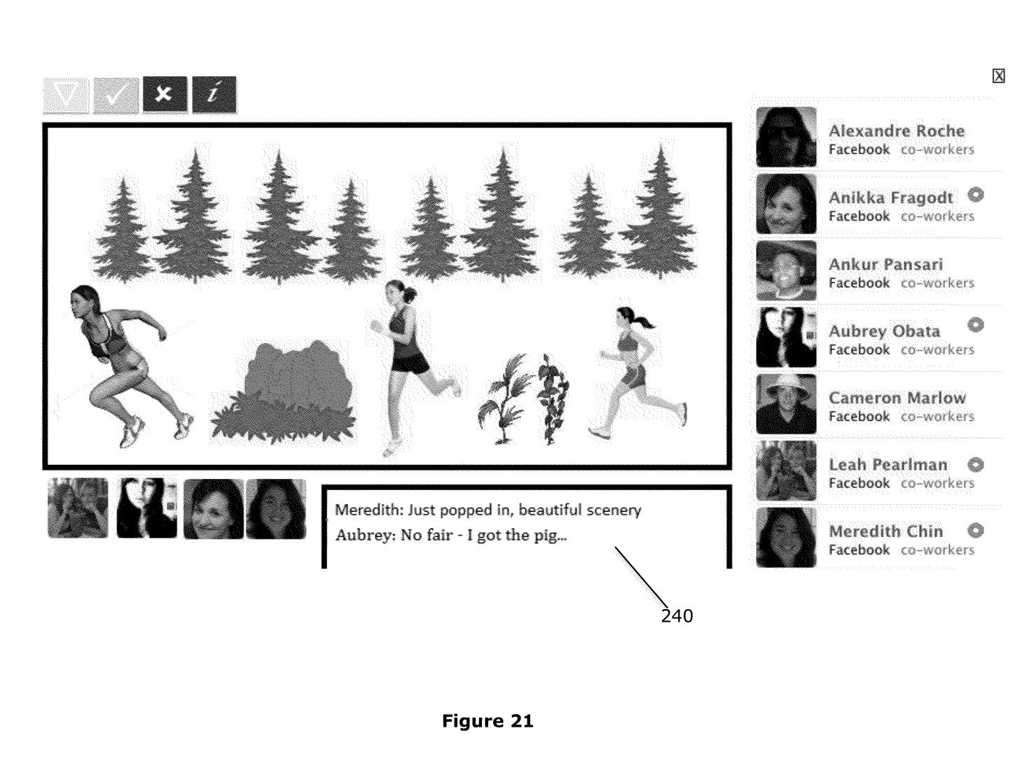

In some embodiments, players who cannot join the game but want to view the game can do so. However, whereas in some embodiments, such as the example illustrated in FIG. 16, viewers may participate in a small aspect of the mini game, in some other embodiments, such as the example illustrated in FIG. 21, viewers may only watch the in-game activity. In some embodiments, said viewer may still use Instant Messaging Platform 240.

The examples given in FIG. 16 and FIGS. 18-21 are merely examples and not exhaustive of available mini games as in-game activities. One of ordinary skill in the art will realize that there are infinite different mini game parameters that can be delineated in a computer generated in-game activity for an example client social game.

B. Quests

In the example social game described here, Quests are player generated in-game activities. In some embodiments, Quests can incentivize players to shop because in some embodiments of the invention, rewards are offered for completing a quest.

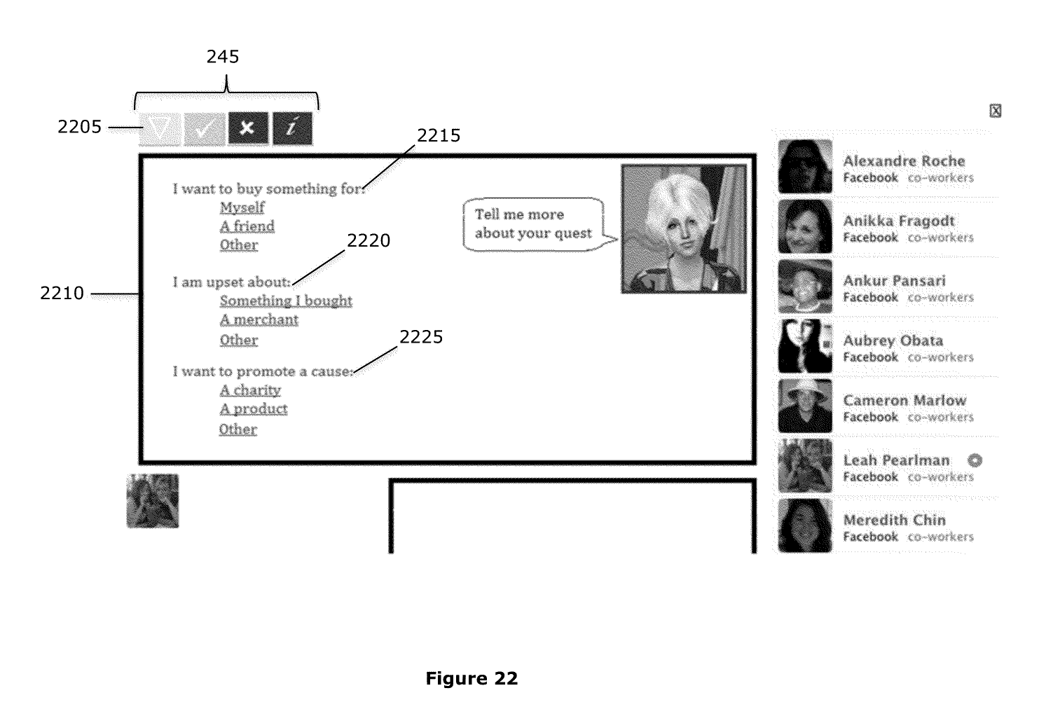

FIG. 22 illustrates GUI 2210 after a first player selects Create Quest button 2205 from list of Game Command Buttons 245. The selection of Quest button 2205 causes the GUI 2210 to display several game interface items to choose a type of Quest. In some embodiments, these game interface items include Purchase Quest button 2215, Expression Quest button 2220, and Promotion Quest button 2225.

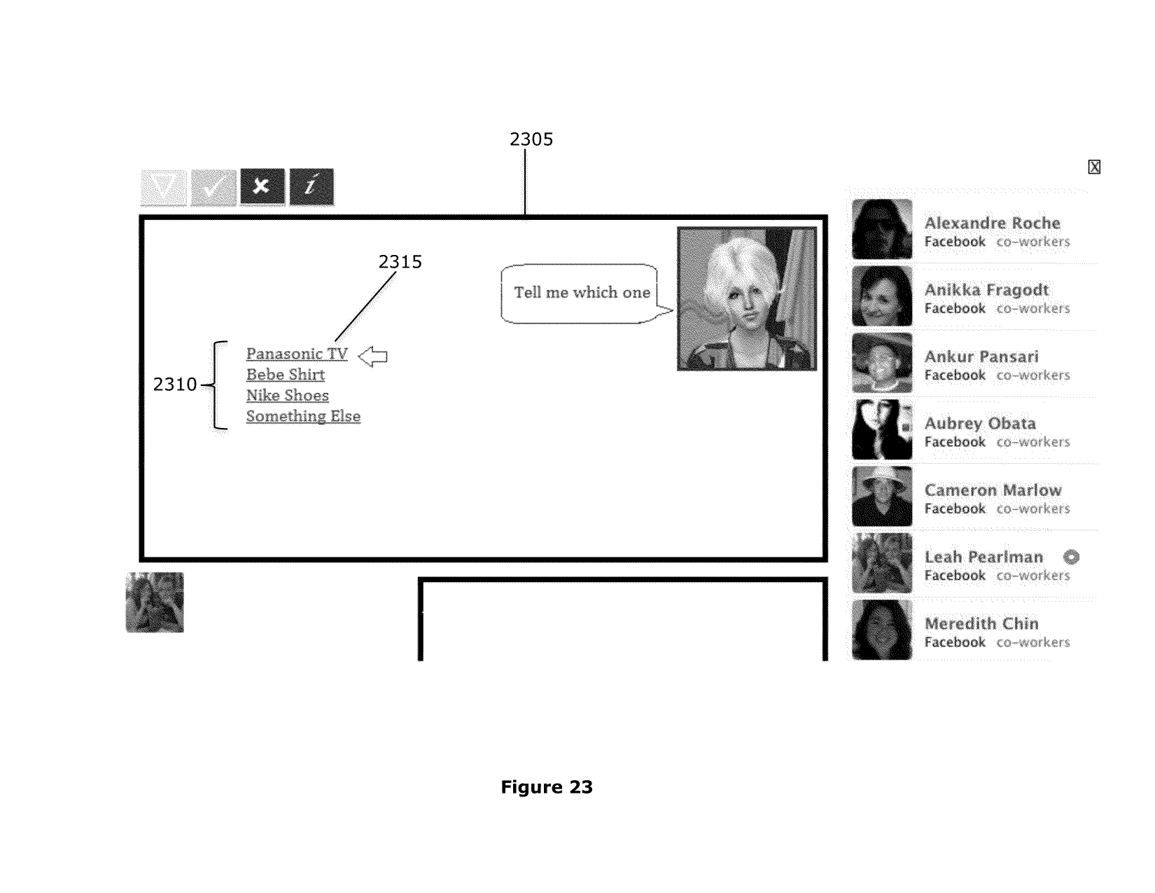

FIG. 23 illustrates GUI 2305 after a first player selects Expression button 2220. GUI 2305 displays a Purchased Item List 2310 of recent purchases that is automatically generated from the game server through information from the first player's data storage. In some embodiments, these items are real goods that the player purchased after first buying the corresponding in-game asset.

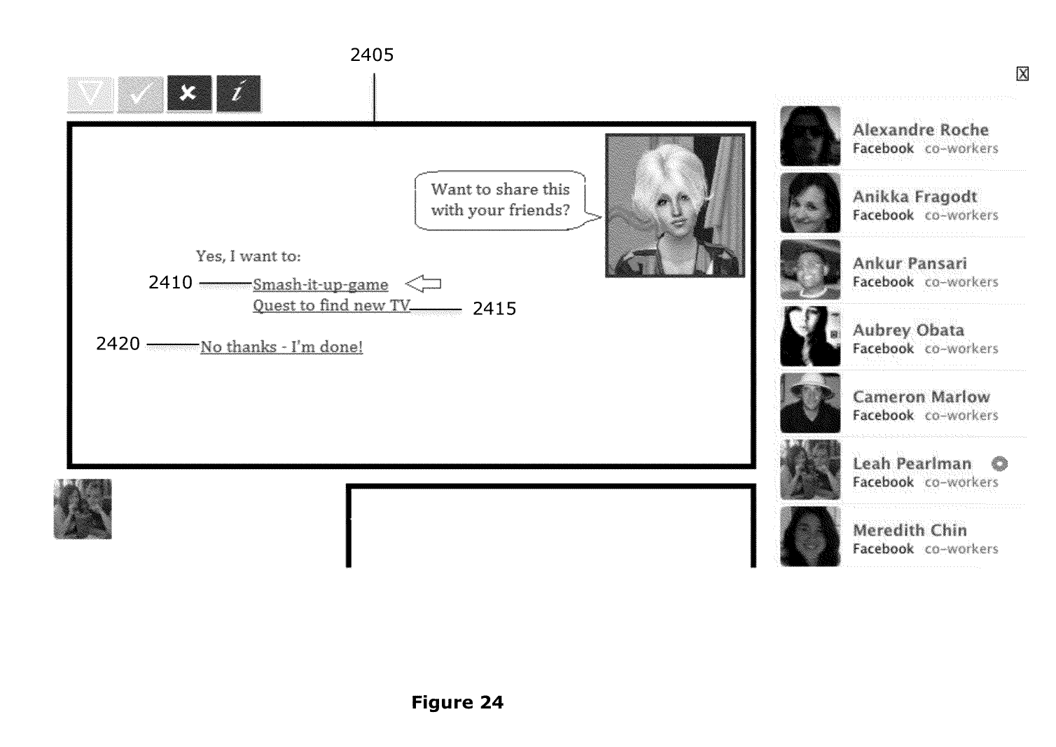

FIG. 24 illustrates GUI 2405 after a first player selects Purchased Item 2315 from Purchased Item List 2310. Selection of Purchased Item 2315 causes GUI 2405 to display several game interface items to finish creating a Quest. Example Quests include but are not limited to inviting friends to “smash up” the graphical representation of Purchase Item 2315 by selecting Create Game button 2410, selecting Shopping Quest button to invite friends to help find a better version of Purchased Item 2315 by selecting Shopping Quest button 2215, or selecting End button 2420 to stop creating a Quest.

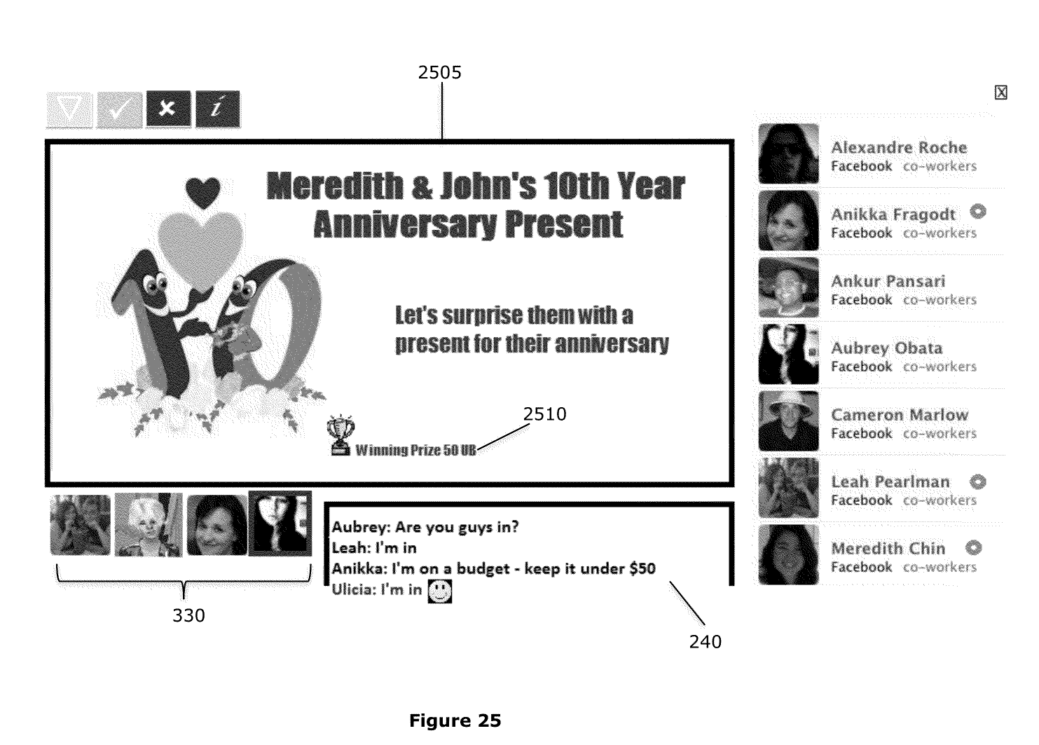

FIG. 25 illustrates GUI 2505 for an example Quest created to shop for other friends by a first player selecting Purchase Quest button 2215 in FIG. 22. In some embodiments, a first player may choose to offer a reward for the player who best completes the Quest as incentive to get other players to join. In the example of FIG. 25, the first player offers a virtual currency award as the Winning Prize 2510. Active Players that accept the Purchase Quest are listed in View list 330. Active players may use Instant Messaging Platform 240 to communicate with each other during the Quest.

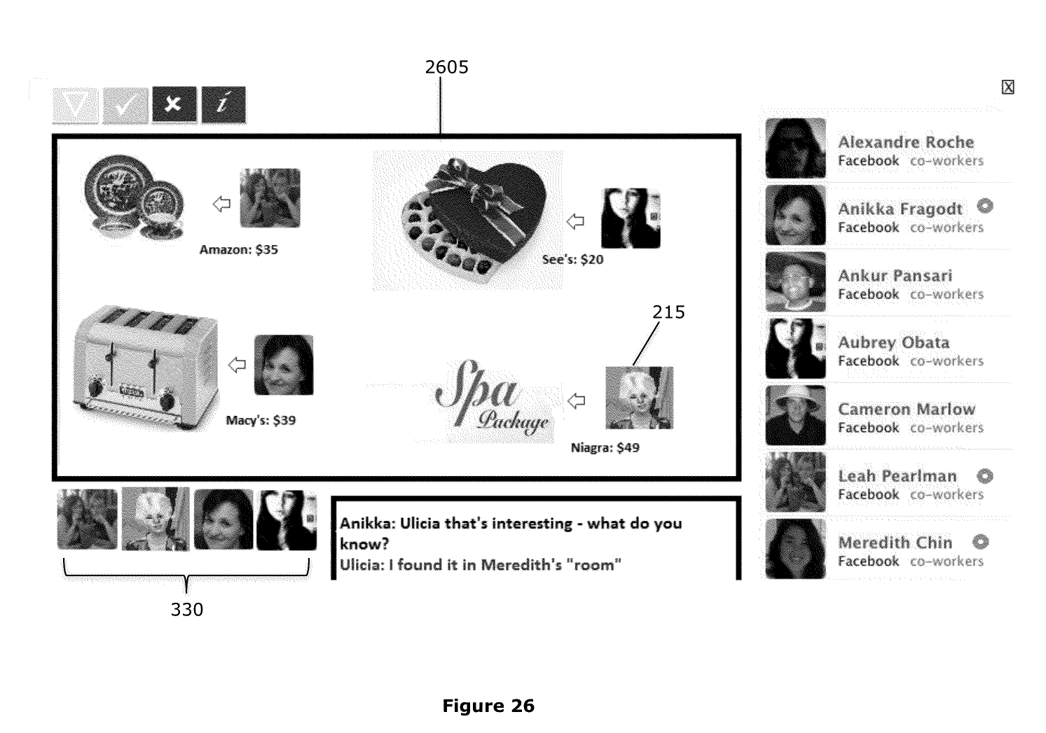

FIG. 26 illustrates GUI 2605 after all Active Players in View List 330 have selected an in-game asset to complete the Purchase Quest illustrated in FIG. 25. In some embodiments, GUI 2605 displays where the real goods or services that correspond to the in-game asset may be purchased. In some embodiments, the best price offered may be through an online ecommerce merchant. In some other embodiments, the best price may be offered through a traditional brick and mortar type store.

In some embodiments, a recommended in-game asset may be automatically generated by the game server and displayed next to graphical representation 215 in GUI 2605 utilizing information about the Purchase Quest recipient that the other players do not know. For example, the game server can determine the Purchase Quest recipient's already purchased in-game assets, purchased real goods and services, and prior sentiments.

The examples given in FIG. 22-26 are merely examples and not exhaustive of available Quests to create as in-game activities. One of ordinary skill in the art will realize that there are many other parameters that can be selected by players to create in-game activities for an example client social game.

III. Overall Architecture and Computer System

FIGS. 27-28 illustrate an example architecture and computer system for implementing various disclosed embodiments. In particular embodiments, the overall game system 2700 is made up of player 2730, player 2735, social network system 2710, game networking system 2715, global computer network 2705, ecommerce network system 2720, and retail network system 2725.

The connections made between the components of the overall game system 2700 may vary in nature and may include a wide-ranging array of computer networking technologies such as Local Area Network (LAN), a Wide Area Network (WAN), a Public Switched Telephone Network (PSTN), or other types of networks which may include more than one type of computer network. The connections throughout the system are not required to be uniform in nature. FIG. 27 illustrates two players, player 2730 and player 2735, one social system 2710, one game network system 2715, one ecommerce system 2720, and one retail network system 2725; however FIG. 27 contemplates any suitable number of players, social network systems, game network systems, ecommerce network systems, and retail network systems.

Social network system 2710 is a network-addressable computing system that maintains one or more social graphs, and serves the other components in the system with social data either directly or through a computer network.

Game network system 2715 is a network-addressable computing system that maintains one or more online games; for each game tracking player and product related data which may include but is not limited to players' account credentials, maps, purchase history, player room data, retailer credentials, product inventories, Shopping Gurus' data, Shopping Aces' data, Shopping Connoisseurs' data, purchase ring sessions data, quest data, and data pertaining to mini-games.

Ecommerce network system 2720 is a network-addressable computing system that maintains one or more online inventories of retail products and makes them available to online human and/or electronic shoppers. Game network system 2715 connects with ecommerce network system 2720 in order to retrieve product data, product inventory, exchange shopper data, exchange shopper sentiments, and negotiate prices.

Retail network system 2725 is a network-addressable computing system that maintains product inventories for a brick and mortar retail chain. Game network system 2715 connects with retail network system 2725 in order to retrieve product inventory, exchange shopper data, exchange shopper sentiments, and negotiate prices. Players interact with the game network system 2715 through a global computer network 2705. Game network system 2715 connects with social network system 2710, ecommerce network system 2720 and retail network system 2725 through one or more computer networks.

Social network system 2710, game network system 2715, ecommerce network system 2720, and retail network system 2725 are all implemented using high throughput server computers; whereas, client systems 2730 and 2735 may be implemented using any suitable computing device, such as personal PCs, laptop PCs, Tablet PCs, and smart phone devices. Global computer network 2705 connects all of the components of the system using a wide-ranging array of suitable devices and connections. For instance, suitable connections may include wired connections such as Cable Modem (Data Over Cable Service Interface Specification (DOCSIS)), Digital Subscriber Line (DSL), and wireless (i.e. WiFi or WiMAX) connections. One of ordinary skill in the art will recognize that global computer network 2705 includes a wide-ranging array of devices and as such the connections made within this network may differ in more than one aspect from each other.

Many of the above-described game network system components and engines are implemented as software processes that are specified as a set of instructions recorded on a machine-readable medium (also referred to as computer readable medium). When these instructions are executed by one or more computational element(s) (such as processors or other computational elements like ASICs and FPGAs), they cause the computational element(s) to perform the actions indicated in the instructions. Computer is meant in its broadest sense, and can include any electronic device with a processor. Examples of computer readable media include, but are not limited to, CD-ROMs, flash drives, RAM chips, hard drives, EPROMs, etc.

In this specification, the term “software” is meant in its broadest sense. It can include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention.

FIG. 28 illustrates a computer system with which some embodiments of the invention are implemented. Computer system 2800 includes a bus 2805, a processor 2810, a system memory 2825, a read-only memory 2830, a permanent storage device 2835, input devices 2840, and output devices 2845.

The bus 2805 collectively represents all system, peripheral, and chipset buses that communicatively connect the numerous internal devices of the computer system 2800. For instance, the bus 2805 communicatively connects the processor 2810 with the read-only memory 2830, the system memory 2825, and the permanent storage device 2835. From these various memory units, the processor 2810 retrieves instructions to execute and data to process in order to execute the processes of the invention.

The read-only-memory (ROM) 2830 stores static data and instructions that are needed by the processor 2810 and other modules of the computer system. The permanent storage device 2835, on the other hand, is a read-and-write memory device. This device is a non-volatile memory unit that stores instructions and data even when the computer system 2800 is off. Some embodiments of the invention use a mass-storage device (such as a magnetic or optical disk and its corresponding disk drive) as the permanent storage device 2835.

Other embodiments use a removable storage device (such as a floppy disk or ZIP® disk, and its corresponding disk drive) as the permanent storage device. Like the permanent storage device 2835, the system memory 2825 is a read-and-write memory device. However, unlike storage device 2835, the system memory is a volatile read-and-write memory, such a random access memory. The system memory stores some of the instructions and data that the processor needs at runtime. In some embodiments, the invention's processes are stored in the system memory 2825, the permanent storage device 2835, and/or the read-only memory 2830. Together or separate, the above mentioned memories and storage devices comprise the computer readable medium of the computer system on which the above described processes are stored and executed from, the content, tags, and tag chains used by the processes are stored.

The bus 2805 also connects to the input and output devices 2840 and 2845. The input devices enable the user to communicate information and select commands to the computer system. The input devices 2840 include alphanumeric keyboards and pointing devices. The output devices 2845 display images generated by the computer system. For instance, these devices display a graphical user interface. The output devices include printers and display devices, such as cathode ray tubes (CRT) or liquid crystal displays (LCD).

Finally, as shown in FIG. 28, bus 2805 also couples computer 2800 to a network 2865 through a network adapter (not shown). In this manner, the computer can be a part of a network of computers (such as a local area network (“LAN”), a wide area network (“WAN”), or an Intranet, or a network of networks, such as the internet. For example, the computer 2800 may be coupled to a web server (network 2865) so that a web browser executing on the computer 2800 can interact with the web server as a user interacts with a graphical user interface that operates in the web browser. Any or all components of computer system 2800 may be used in conjunction with the invention.

While the invention has been described with reference to numerous specific details, one of ordinary skill in the art will recognize that the invention can be embodied in other specific forms without departing from the spirit of the invention. For instance, a person of ordinary skill in the art would realize that the invention may be practiced in several different operating environments such as Microsoft Windows®, UNIX®, Linux, etc.

What is claimed is:

1. A computer implemented method comprising:
receiving a request from a first player in an interactive social game for an in-game asset;
presenting a plurality of in-game asset options to the first player, of which each in-game asset option may be viewable by one or more second players and by one or more Special Players who can communicate with the first player;
receiving an in-game asset selection from the first player; and
delivering a graphical expression of said in-game asset selection to the first player.

2. The computer-implemented method of claim 1, wherein said in-game asset options are virtual representations of real world goods and services.

3. The computer-implemented method of claim 1, wherein said in-game asset options have associated selection costs.

4. The computer-implemented method of claim 1, wherein said in-game asset selection may have utility in one or more in-game activities.

5. A non-transitory machine-readable medium storing a computer program for execution by at least one processor, the computer program comprising sets of instructions for:
receiving identification of a request from a first player in an interactive social game for an in-game asset;
presenting a plurality of in-game asset options to the first player, of which each in-game asset option may be viewable by one or more second players and by one or more Special Players who can communicate with the first player;
receiving identification of an in-game asset selection from the first player; and
delivering a graphical expression of said in-game asset selection to the first player.

6. The non-transitory computer readable medium of claim 5, wherein said in-game asset options are virtual representations of real world goods and services.

7. The non-transitory computer readable medium of claim 5, wherein said in-game asset options have associated selection costs.

8. The non-transitory computer readable medium of claim 5, wherein said in-game asset selection may have utility in one or more in-game activities.

9. A computer-implemented method comprising:
presenting a plurality of in-game activity options to the first player in an interactive social game;
receiving an in-game activity selection from the first player;
identifying one or more second player selections of said in-game activity;
identifying a reward for completion of said in-game activity;
initiating said in-game activity;
receiving an indication that said in-game activity is complete; and
delivering said reward upon completion of said in-game activity.

10. The computer-implemented method of claim 9, wherein in-game activity options include computer generated events based on a player's character state, and player generated events.

11. The computer-implemented method of claim 10, wherein a player's character state is determined by type and number of in-game assets owned by a player.

12. The computer-implemented method of claim 9, wherein identifying one or more second player selections of said in-game activity terminates upon initiation of said in-game activity.

13. The computer-implemented method of claim 9, wherein said reward includes at least one of a virtual currency, an in-game asset, real currency, or real goods and services.

14. A non-transitory machine-readable medium storing a computer program for execution by at least one processor, the computer program comprising sets of instructions for:
presenting a plurality of in-game activity options to the first player in an interactive social game;
receiving identification of an in-game activity selection from the first player;
identifying one or more second player selections of said in-game activity;
identifying a reward for completion of said in-game activity;
initiating said in-game activity;
receiving identification of an indication that said in-game activity is complete; and
delivering said reward upon completion of said in-game activity.

15. The non-transitory computer readable medium of claim 14, wherein in-game activity options include computer generated events based on a player's character state, and player generated events.

16. The non-transitory computer readable medium of claim 15, wherein a player's character state is determined by type and number of in-game assets owned by a player.

17. The non-transitory computer readable medium of claim 14, wherein identifying one or more second player selections of said in-game activity terminates upon initiation of said in-game activity.

18. The non-transitory computer readable medium of claim 14, wherein said reward includes at least one of a virtual currency, an in-game asset, real currency, or real goods and services.
